(19) United States
(12) Patent Application Publication
(10) Pub. No.: US 2007/0046695 A1
(43) Pub. Date: Mar. 1, 2007

(54) System and method for computer aided design

(75) Inventors: Eberhard Bamberg, Salt Lake City, UT (US); Shreyas Hoskere, Salt Lake City, UT (US)

Correspondence Address: THORPE NORTH & WESTERN, LLP., 8180 SOUTH 700 EAST, SUITE 200, SANDY, UT, 84070, US

(73) Assignee: University of Utah, Salt Lake City, UT (US)

(21) Appl. No.: 11/509,459

(22) Filed: Aug. 23, 2006

Related U.S. Application Data
(60) Provisional application No. 60/710,479, filed on Aug. 23, 2005.

(51) Int. Cl. G09G 5/00

(52) U.S. Cl. 345/619

(57) ABSTRACT

The invention provides a system and method for computer aided design. The system can include an electronic design tool configured to model a mechanical system. A first view type window can be in communication with the electronic design tool. In addition, a second view type window can be in communication with the electronic design tool. The second view type window can be simultaneously viewable with the first view type window. A drawing interface can be provided that is common to the first view type window and the second view type window in which design elements are capable of being drawn. A design element started in a first view window is capable of being completed in a second view window.

Priority of U.S. Provisional patent application Ser. No. 60/710,479 filed on Aug. 23, 2005 is hereby claimed.

### FIELD OF THE INVENTION

The present invention relates to the field of computer aided design.

### BACKGROUND

Computer-aided design (CAD) or computer-aided design and drafting (CADD) are forms of computer automation that help engineers or designers prepare drawings, specifications, parts lists, artistic designs, and other related elements using special graphics and calculation-intensive computer programs. For example, CAD technology can be used to develop a wide variety of products in such fields as architecture, electronics, manufacturing, aerospace, naval, automotive engineering, and many others.

Although CAD systems were originally just automated drafting systems, these systems now include three-dimensional modeling features and even computer-simulated operation of a model. Rather than having to build prototypes and change components to determine the effects of tolerance ranges, engineers can use computers to simulate operations while determining loads and stresses.

As microelectronic devices have become smaller and more complex, CAD and rapid prototyping have become a more important technology. Among the benefits of such systems are lower product-development costs and a greatly shortened design cycle.

Less expensive CAD systems running on personal computers have even become available for do-it-yourself home remodeling and simple drafting. State-of-the-art CAD systems running on workstations and mainframe computers are increasingly integrated with computer-aided manufacturing systems.

One unexpected drawback of CAD systems is that because of a CAD system's complexity and accuracy it can be difficult for an engineer to rapidly prototype a machine or design. Consider the design of a new machine that may be quickly sketched on a sheet of paper or the back of an envelope when a new design is conceptualized. Despite the fact that a hand written design can be generated quickly, such a manual design is difficult to validate. In contrast, the same conceptual idea may take hours upon hours to generate in a detailed CAD design format but this design can be more easily verified as a workable design. This dichotomy can be problematic when a large amount of time is spent or wasted on a CAD design for an experimental machine design that may not even be workable in the end.

### SUMMARY OF THE INVENTION

The invention provides a system and method for computer aided design. The system can include an electronic design tool configured to model a mechanical system. A first view type window can be in communication with the electronic design tool. In addition, a second view type window can be in communication with the electronic design tool. The second view type window can be simultaneously viewable with the first view type window. A drawing interface can be provided that is common to the first view type window and the second view type window in which design elements are capable of being drawn. A design element started in a first view window is capable of being completed in a second view window.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a screen view of three orthogonal views and an isometric perspective view of a computer aided design tool in accordance with an embodiment of the present invention;

FIG. 2 illustrates that the computer aided design tool can capture constraints from the two-dimensional models and can apply the constraints to the three-dimensional renderings in accordance with an embodiment of the present invention;

FIG. 3 illustrates node to depth color coding in accordance with an embodiment of the present invention;

FIG. 4 depicts an application window that enables beam cross section properties to be applied to elements being drawn in accordance with an embodiment of the present invention;

FIG. 5 illustrates that every modeled element may be interpreted as a finite element in an embodiment;

FIG. 6 illustrates an example of a bearing and ball screw stiffness database that can be incorporated in an embodiment of the present invention;

FIG. 7 illustrates that the electronic sketches may be exported to an external finite element package for evaluation; and

FIG. 8 is a flow chart illustrating computer aided design operations that can be executed in an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

An embodiment of the present system and method includes a conceptual automated design tool with an N-way split window and 3D parametric sketching. Sketching of the conceptual design can be done across all views and view types, meaning the sketching or introduction of a design feature or element can be initiated in any view or view type and finished in any view or view type, including the isometric view.

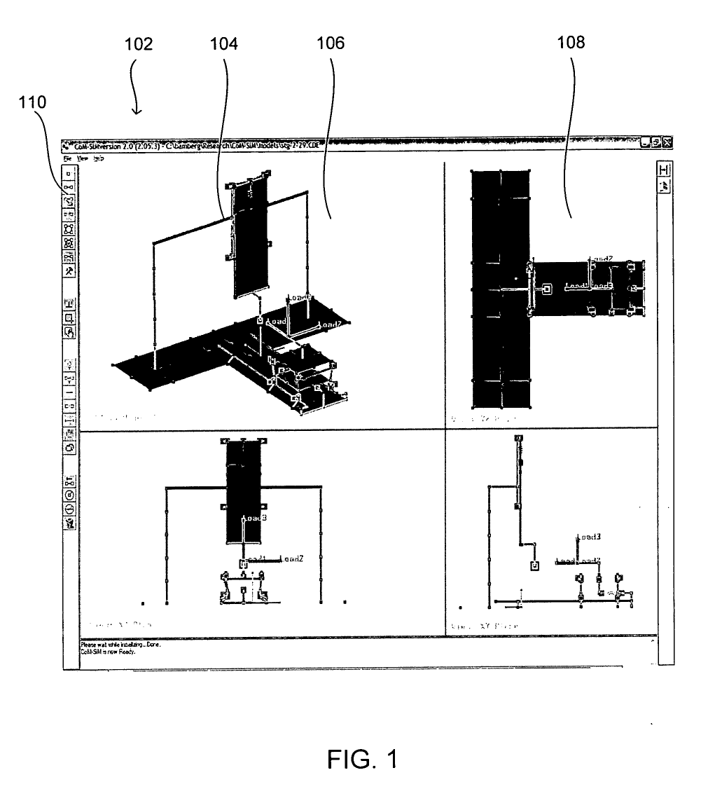

FIG. 1 illustrates an embodiment of a system for computer aided design. The system can include an electronic design tool 102 configured to model a mechanical system 104. The electronic design tool can include a first view type window 106. In addition, a second view type window 108 is included with the electronic design tool. The second view type window can be simultaneously viewable with the first view type window.

The first view type window and/or the second view type window can be selected from the group that includes: an orthogonal view, a perspective view, a true perspective view, and an isometric perspective view. FIG. 1 illustrates an example embodiment of three orthogonal views and an isometric perspective view. As many mechanical machine designs and their axes are configured orthogonal to each other, this graphical sketching mechanism allows faster sketching and visualization of the drawn model.

The conceptual design system can include a number of embodiments. Other combinations of perspective type windows and orthogonal type windows can also be used. One configuration may be a single perspective view and a single orthogonal view that can be used simultaneously. In another embodiment, there may be two perspective views and four orthogonal views. Yet another embodiment may use just orthogonal views.

Other axes may be used for machine designs that use alternative axes schemes. In addition, a true perspective view or another 3D style view may be used in place of an isometric view. More than one isometric or other perspective view can also be used to provide different perspectives, as desired.

The number of orthogonal views that are used may also vary from just one orthogonal view to an orthogonal view for each of 6 separate orthogonal views of a device. It has been found that three orthogonal views is a useful number of views in many situations. More than six orthogonal views may be used where repeated sides or zoom views of the sides are needed.

The orthogonal views may also be moved to a point inside the boundaries of the modeled machine or device. This allows the end user to focus on a specific detailed part of the machine while moving the camera point past areas that are not relevant or that are already complete.

A drawing interface 110 is included in the electronic design tool. The interface is common to the first view type window and the second view type window in which design elements are capable of being drawn. A design element started in a first view window is capable of being completed in a second view window.

For example, an anchor point for an element can be established in the isometric view and then the pointer can be immediately moved to a simultaneously viewable orthogonal window where one or more completion points and any remaining details can be completed. In one embodiment, 4 or more panes can be provided for the electronic sketching and design.

The first anchor point for a design element can be started in either the orthogonal view or a perspective view window. Then the second anchor point can be finished in a different orthogonal view or perspective view. In the event the element is more easily drawn in a single view, the design element may be completed in the same view.

An alternative embodiment of the invention can include a small 3D inset window that is inset into a major drawing window that primarily used for orthogonal drawing. In addition, a small 3D inset window may be used with anywhere from 1-6 orthogonal windows. In one configuration of the design system a perspective view is inset into at least one orthogonal view window. Alternatively, one or more orthogonal views can be inset into the perspective view. A graphical control for swapping either the inset views or the base drawing view may also be included.

The present system and method captures some of the speed benefits of sketching models on paper. However, the rough electronic model can be exported to finite element programs for analysis of performance criteria such as stiffness, loop stiffness, bearing loads, modal frequencies, mass, etc. In addition, the present system and method provides a 3D conceptual design and evaluation CAD tool to aid designers in prototyping and evaluating precision machine designs and/or mechanical systems with the associated bearing and ball screw systems simultaneously.

The design tool can include a linked-in database for bearings and ball screws, which allows complex designs such as machine tools be designed in a short amount of time. By including the effects of bearings and ball screws, performance critical criteria such as loop stiffness, bearing loads, etc., can be determined very quickly. This design system allows many different prototype designs to be compared objectively and optimized, if desired.

As discussed previously, the present invention allows a designer to seamlessly and continuously move the drawing focus between several simultaneous views. The user can start drawing a feature (beam, spring, plate, etc.) in one view pane, edit the feature in another view pane, and seamlessly complete the feature in another view. This also means the drawing output can take place simultaneously in all views.

A reference point for a new feature is often easier to find on an orthogonal model and the first feature point can be drawn in an isometric view. Moreover, the completion of the sketching is generally easier to complete in orthogonal views. This system and method allows a designer to seamlessly move back and forth between these views in a high speed manner because the windows are displayed simultaneously and are immediately updated with the information and changes made in simultaneously viewable windows.

In prior art computer aided design (CAD) systems, the designer takes a significant amount of time to orient the view plane in the desired orientation. Then the desired face of the object is selected and brought parallel to the screen face. If a designer desires to switch views for drawing, then these orientation steps are repeated in order to start drawing from another perspective. This prior art method is a time consuming and laborious process when compared to the present invention.

An embodiment of the present invention includes 3D Parametric dimensioning and constraining of sketches. By including a robust “non-linear” equation optimizer, the present system can provide 3D parametric dimensioning capabilities. This allows three-dimensional models to be sketched that are fully parametric, meaning the model will become updated automatically in order to reflect changes to any of its dimensions.

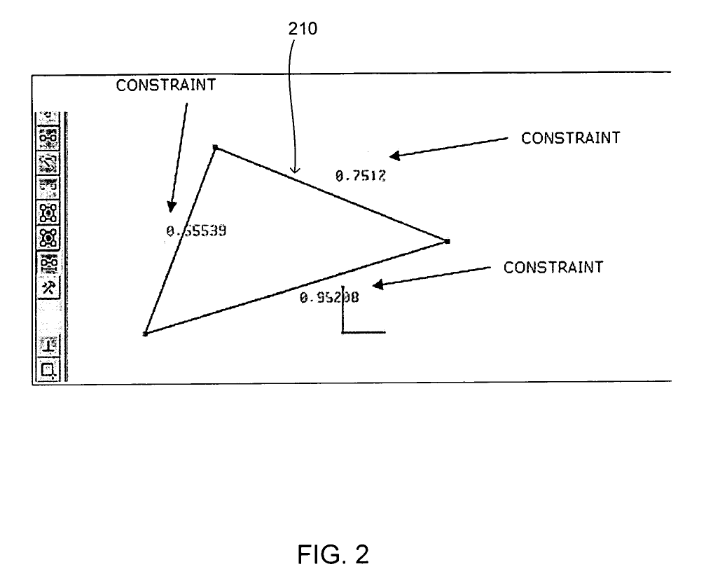

The maintenance of elements when other elements change, as illustrated in FIG. 2, is valuable because specific relationships or defined interactions can be maintained even when one element is changed. The present system can capture the constraints from the two-dimensional models 210 and can then apply the constraints to the three-dimensional renderings. These constraints can also maintain certain orientations for the system being created. For example, the design system can maintain lengths, angles, parallel objects, orthogonal objects, and other geometry constraints.

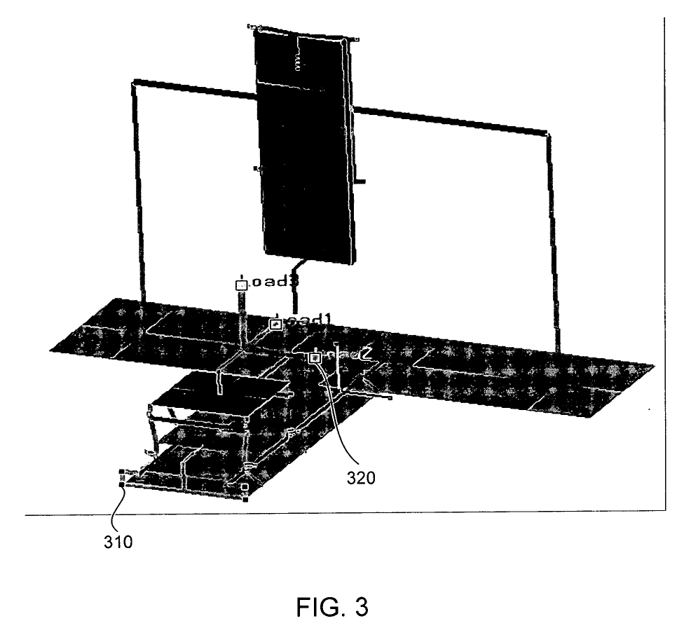

The present system and method includes node to depth color coding as illustrated in FIG. 3. It can be difficult to intuitively visualize 3D wire frames or sketches on a 2D computer screen unless a color or intensity coding system is implemented that changes node color values depending on the node distance to the origin. In one embodiment, a “binary” color scale can be used, where drawing nodes that are closer to the user are a dark color 310 and nodes that are further away are light in color 320. A grey scale approach can be used where the nodes are different shade of grey based on calculated distances from an assumed viewpoint. In other words, each design element can have a plurality of nodes that are intensity coded based on node depth in a view window. This aids the designer in mentally identifying where the sketching plane is located the 3D views.

Alternatively, a grading of colors may be used. For example, dark colors such as blues, purples or black can be used for nodes that are close to the designer. Light colors such as red, yellow and other light colors can be used for nodes that are father away. Another example would be just using the same color for all the nodes but making the nodes a dimmer color when the nodes are farther from the designer. Each design element can have a plurality of nodes that are color coded based on node depth in a view window.

This present system and method may include the idealization of sketch elements as finite elements. This allows the machine and model to be simplified, which in turn speeds design time. Every sketched element in the multi-window sketching tool may be interpreted as a finite element. This allows the designer to sketch models as idealized beams, plates, springs, etc., in order to easily evaluate the sketch objectively.

All the sketched elements can be selected to be any one of the several finite element idealizations available from an element database. For example, a finite element can be defined as a beam, truss, plate/shell, spring or pipe. These finite element properties can be defined in an element database from which the end user or designer can select and apply to the feature or element being sketched.

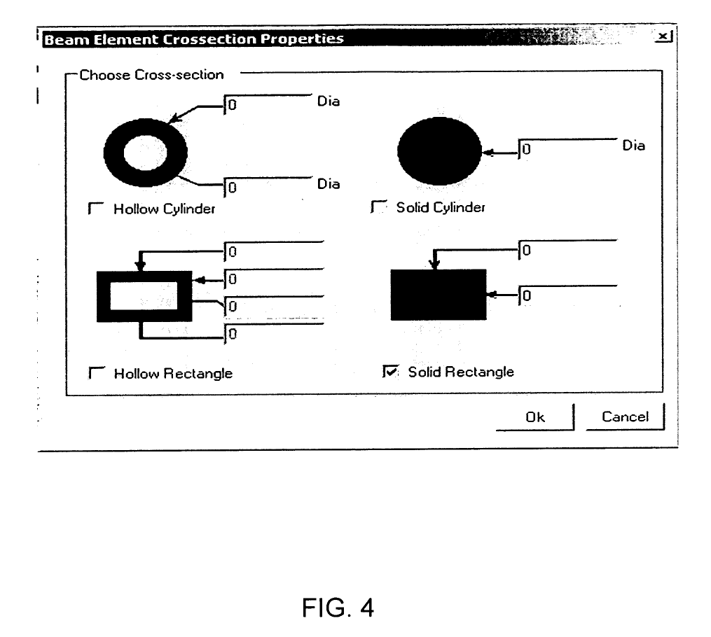

FIG. 4 illustrates that beam cross section properties from a beam section database can be applied to elements being sketched. To apply beam cross section properties, the present system has a database of many common beam cross sections which may be easily applied to the sketched elements.

Finite element load and boundary conditions can also be included in the system and method. Boundary and load conditions on the nodes of the sketch can be selected or set as a property. Picking nodes in any of the view panes or view types is possible. Then the boundary and load conditions can be applied to the node regardless of whether the node is in the orthogonal, isometric or perspective views.

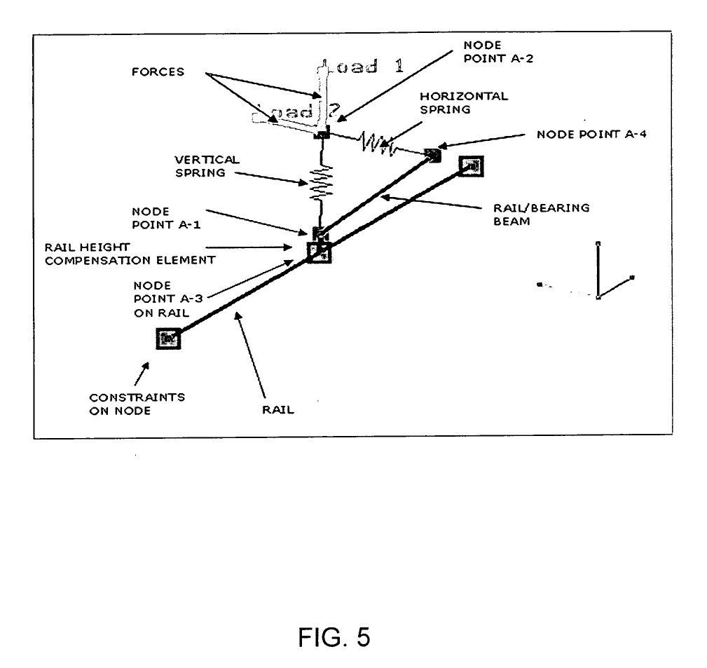

Each design element can be treated as a finite element under finite element analysis. The present system and method can include tools to calculate and simplify ball screws/bearing systems into spring elements. Every sketched element in the present embodiment is interpreted as a finite element. This allows sketching of models as idealized beams, plates, springs, etc., in order to easily evaluate the sketch objectively. FIG. 5 illustrates an embodiment of this idealization feature.

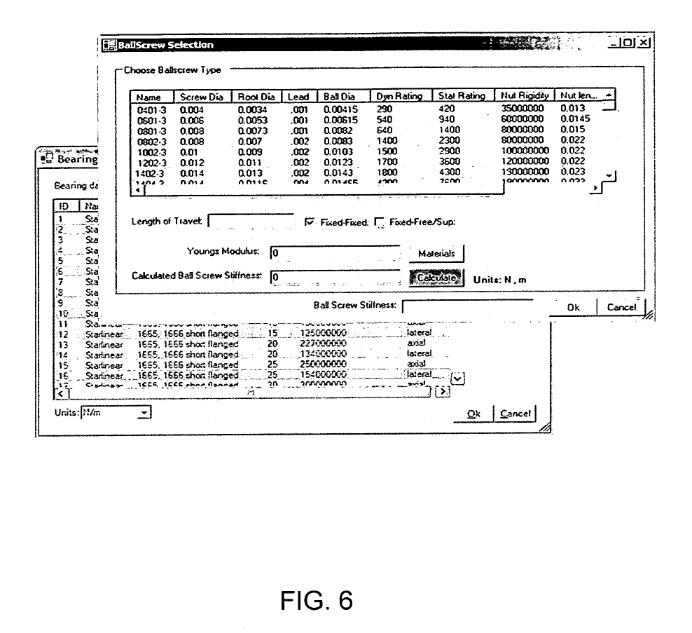

Accurate simplification of linear bearing systems is achieved by maintaining an extensive bearing and ball screw stiffness database. The present system and software application can also have a ball screw database and a ball screw stiffness calculator making it the first 3D parametric precision machine tool CAD package ever built. FIG. 6 illustrates an example of this bearing and ball screw stiffness database.

An element material database can also be included in the present system and method. For example, element types can be assigned to each finite element in the model. Assigning material properties can be done by using an available material database in the present system.

Once the model sketch is completed, the sketch may be exported to an external finite element package for evaluation. For example, the ANSYS™ software package may be used. Due to the modular design of the present embodiment, it is straight-forward to write software modules to export the sketch to any other finite element package, as desired.

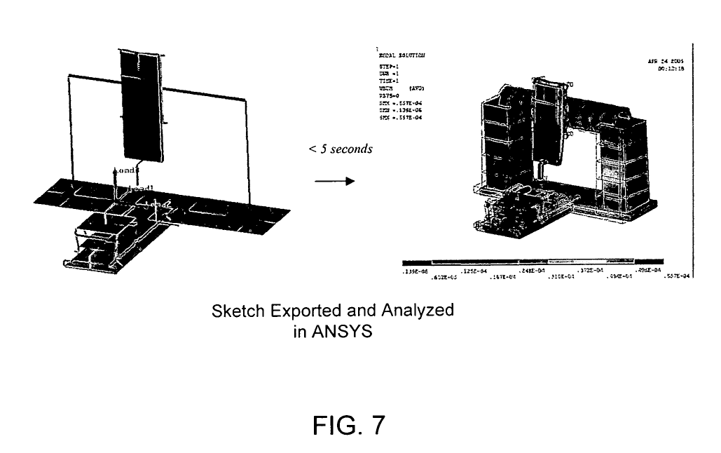

The evaluation of a fairly complex machine concept such as a 5-axis machine tool with its bearing and ball screw systems) may take less than five seconds. FIG. 7 illustrates that the model or sketch can be exported and then the external finite evaluation can take place in a finite element evaluation tool.

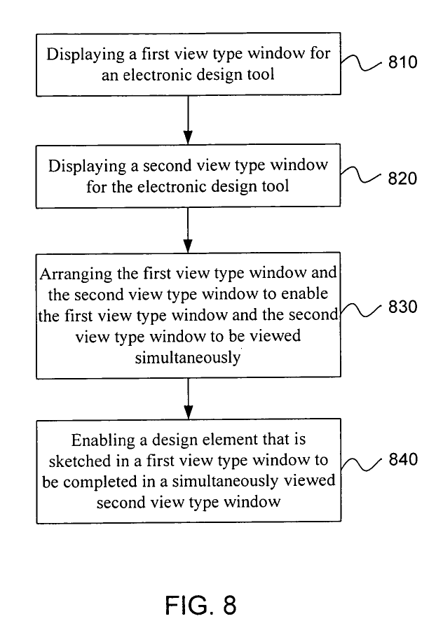

A flowchart of a method for computer aided design is illustrated in FIG. 8. A first operation is displaying a first view type window for an electronic design tool, as in block 810. A second view type window can also be displayed for the electronic design tool, as in block 820. The first window type and the second view type window can be: an orthogonal view, a perspective view, a true perspective view, an isometric perspective view, or another known view type.

A further operation can be arranging the first view type window and the second view type window to enable the first view type window and the second view type window to be viewed simultaneously, as in block 830. The view type windows may be adjacent or spread apart on a computer desktop. Then a design element that is sketched in a first view type window can be completed in a simultaneously viewed second view type window, as in block 840.

For example, the end user can pick which window to start drawing in. The user will usually pick the window where the desired point is easiest to identify. Clicking or making some other user input into the first window can create a first node in the first view type window in response to a user input.

Then the user can hold down a mouse button to drag a pointer into the second view type window. When the drag operation mouse button is released then a second node may be created in the second view type window in response to the user input or event. The second node can also be created by just clicking in the window without a dragging operation. The user input can create a design element that is displayed in both windows based on the combination of the first and second nodes created in separate views. Users may also create design elements that include multiple nodes. A tool can be provided that allows a user to create nodes that are connected in a polygon shape or right angle fashion.

Once the nodes have been defined across the separate windows then a design element can be generated from the first and second nodes, and the design element will be consistent between both views. This completion of design elements can be performed in more than one way. In one embodiment, a master database of points can be kept and the views are updated based on this underlying model structure.

In summary, the present system and method includes:
1. Simultaneous sketching or drawing across multiple views.
2. A built-in database for bearings, ball screws, motors, sensors, etc.
3. Conceptual designs that can be analyzed using finite element methods.
4. Finite element analysis times are short due to inherent idealizations of all elements used.
5. Precision machine design, conceptual design, robotics, product development, and design optimization

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A system for computer aided design, comprising:
an electronic design tool configured to model a mechanical system;
a first view type window, in communication with the electronic design tool;
a second view type window in communication with the electronic design tool, the second view type window being simultaneously viewable with the first view type window; and
a drawing interface common to the first view type window and the second view type window in which design elements are capable of being drawn, wherein a design element started in a first view window is capable of being completed in a second view window.

2. A system as in claim 1, wherein the first view type window and the second view type window can be selected from the group consisting of: an orthogonal view, a perspective view, a true perspective view, and an isometric perspective view.

3. A system as in claim 2, wherein the orthogonal view includes a plurality of orthogonal drawing views and a design element started in a first orthogonal view window is capable of being completed in a perspective view window.

4. A system as in claim 2, wherein the orthogonal view includes a plurality of orthogonal drawing views and a design element started in a first orthogonal window is capable of being completed in a second orthogonal window.

5. A system as in claim 2, wherein the orthogonal view includes a plurality of orthogonal drawing views and a design element started in a perspective view window is capable of being completed in an orthogonal view window.

6. A system as in claim 2, wherein a perspective view is inset into at least one orthogonal view window.

7. A system as in claim 1, wherein each design element is treated as a finite element under finite element analysis.

8. A system as in claim 1, wherein each design element has a plurality of nodes that are intensity coded based on node depth in a view window.

9. A system as in claim 1, wherein each design element has a plurality of nodes that are color coded based on node depth in a view window.

10. A method for computer aided design, comprising the steps of:
displaying a first view type window for an electronic design tool;
displaying a second view type window for the electronic design tool;
arranging the first view type window and the second view type window to enable the first view type window and the second view type window to be viewed simultaneously; and
enabling a design element that is sketched in the first view type window to be completed in the second view type window.

11. A method as in claim 10, further comprising the steps of:
creating a first node in the first view type window in response to a user input;
creating a second node in the second view type window in response to a user input;
creating a design element that is displayed in both windows based on the combination of the first and second nodes in separate views.

12. A method as in claim 11, further comprising the step of dragging a pointer from the first node in the first view type window to the second view type window to create a second node.

13. A method as in claim 12, further comprising the step of generating a design element from the first and second node that is consistent between both views.

14. A method as in claim 11, wherein the first view type window and the second view type window can be selected from the group consisting of: an orthogonal view, a perspective view, a true perspective view, and an isometric perspective view.

15. A method as in claim 15, further comprising the step of displaying the perspective view as an inset into at least one orthogonal view window.

16. A method as in claim 11, further comprising the step of displaying a plurality of nodes for each design element that are intensity coded based on node depth in a view window.

17. A method as in claim 11, further comprising displaying each design element with a plurality of nodes that are color coded based on node depth in the view window.

18. A method for computer aided design, comprising the steps of:
displaying an orthogonal view window for an electronic design tool;
displaying an isometric view window for the electronic design tool that is simultaneously viewable with the orthogonal view;
arranging the orthogonal view window and the isometric view window to enable the orthogonal view window and the isometric view window to be viewed simultaneously; and
enabling a design element that is drawn in either of the orthogonal view window or the isometric view window to be completed in either view window.

19. A method as in claim 19, further comprising the step of dragging a pointer from a first node in either of the orthogonal view window or the isometric view window to a remaining respective view window to create a second node to complete the design element.

20. A method as in claim 19, further comprising the steps of:
creating a first node in either of the orthogonal view window or the isometric view window in response to a user input;
creating a second node in either of the orthogonal view window or the isometric view window in response to a user input;
creating a design element that is displayed in both windows based on the combination of the first and second nodes in separate views.
